(19) United States
(12) Patent Application Publication
(10) Pub. No.: US 2002/0041831 A1
(43) Pub. Date: Apr. 11, 2002

(54) Externally controllable surface coatings for microfluidic devices

(76) Inventors: C. Frederick Battrell, Redmond, WA (US); Mingchao Shen, Seattle, WA (US)

Correspondence Address: JERROLD J. LITZINGER, SENTRON MEDICAL, INC., 4445 LAKE FOREST DR., SUITE 600, CINCINNATI, OH, 45242, US

(21) Appl. No.: 09/954,405

(22) Filed: Sep. 17, 2001

Related U.S. Application Data
(60) Provisional application No. 60/233,396, filed on Sep. 18, 2000.

(51) Int. Cl. G01N 27/447

(52) U.S. Cl. 422/100; 436/180; 204/600; 204/451; 204/454; 205/601

(57) ABSTRACT

A microfluidic device having a coating on a surface which surface properties can be altered by applying an external stimulus. Such a surface change may be used to guide or direct fluid on these surfaces, thus controlling flow in the microfluidic system.

### CROSS REFERENCE TO RELATED APPLICATIONS

This patent application claims benefit from U.S. Provisional Application Serial No. 60/233,396, filed Sep. 18, 2000, which application is incorporated herein by reference.

### BACKGROUND OF THE INVENTION

1. Field of the Invention

This invention relates generally to microfluidic devices and, in particular, to devices having a coating on surfaces within said devices, where the properties of the coating may be altered by applying an external stimulus such as voltage or light to affect fluid flow within said devices.

2. Description of the Prior Art

Microfluidic devices have recently become popular for performing analytical testing. Using tools developed by the semiconductor industry to miniaturize electronics, it has become possible to fabricate intricate fluid systems which can be inexpensively mass produced. Systems have been developed to perform a variety of analytical techniques for the acquisition of information in many fields, such as the medical field.

Microfluidic technology can be used to deliver a variety of in vitro diagnostic applications at the point of care, including blood cell counting and characterization, and calibration-free assays directly in whole blood. There are also other applications for this technology, including food safety, industrial process control, and environmental monitoring. The reduction in size and ease of use of these systems allows the devices to be deployed closer to the patient, where quick results facilitate better patient care management, thus lowering healthcare costs and minimizing inconvenience. In addition, this technology has potential applications in drug discovery, synthetic chemistry, and genetic research.

Microfluidic devices may be constructed in a multi-layer laminated structure where each layer has channels and structures fabricated from a laminate material to form microscale voids or channels where fluids flow. A microscale channel is generally defined as a fluid passage which has at least one internal cross-sectional dimension that is less than 1 mm and typically between about 0.1 μm and about 500 μm. The control and pumping of fluids through these channels is affected by either external pressurized fluid forced into the laminate, or by structures located within the laminate.

Control of fluid movement within microfluidic channels is usually accomplished by the use of mechanical valves. An example of such a valve is taught in U.S. Patent Application No. 09/677,250, entitled “Valve for Use In Microfluidic Structures”, filed Oct. 2, 2000, and is assigned to the assignee of the present invention. This application describes a valve manufactured from a flexible material which allows one-way flow through microfluidic channels for directing fluids through a microfabricated analysis cartridge. This type of valve, however, is often difficult to fabricate due to its extremely small dimensions.

It has also been proposed to use passive or nonmechanical means to control fluid movement in microfluidic channels. U.S. Pat. No. 6,193,471 is directed to a process and system for introducing menisci, arresting the movement of menisci at defined locations within the system, and for removing menisci from capillary volumes of a liquid sample, as well as delivering precise small volumes of liquid samples to a point of use.

U.S. Pat. No. 6,130,098, which issued on Oct. 10, 2000, is directed to microscale devices using flow-directing means including a surface tension gradient mechanism in which discrete droplets are differentially heated and propelled through etched channels. Electronic components are fabricated on the same substrate material, allowing sensors and controlling circuitry to be incorporated in the same device.

Physical surface features of fluid containing solids are known to affect the behavior of fluids moving through microfluidic channels. For example, U.S. Pat. No. 6,143,248 describes a device having means for controlling pressures necessary for flow comprising textures in the surface material, such as concentric rings around the exit post, as such textures have increased resistance to flow along the surface relative to a smooth surface. It also teaches that the precise shape of a capillary orifice affects the applied pressures at which microvalves permit fluid flow.

U.S. Pat. No. 6,056,860uses surface modifications to effect movement of entities through a medium in electrophoretic applications, as various means have been developed for the surface modification of materials employed in these applications. Surface modification techniques include physical or chemical alteration of the material surface, such as etching, chemical modification, and coating a new material over the existing surface (radiation grafting, vapor deposition, or solvent coating). In this patent, an electrophoretic layer is used to move entities through a medium under the influence of an applied electric field.

U.S. Pat. No. 6,238,538 teaches a microfluidic device using electroosmotic fluid control systems which generally require channels having surfaces with sufficient zeta potentials to propagate an acceptable level of electroosmotic mobility within the channels. Surface modification of the polymeric substrates used in these devices may take on a variety of different forms, including coating those surfaces with an appropriately charged material, derivatizing molecules present on the surface to yield charged groups on that surface, or coupling charged compounds to the surface.

The properties of some surfaces can be changed by applying an external stimulus such as voltage or light. Examples are photosensitive materials that break down into their components, or molecules that reverse their orientation upon being exposed to a certain trigger voltage. As a result of such surface changes, for example, a surface can change from being hydrophilic to hydrophobic. This change can be reversible or irreversible.

Such a surface change can be used to guide or divert fluid flow on these surfaces, or, if the surfaces are part of a channel system, can control flow in microfluidic system. An example for such a surface coating is a photoresist, a UV curable adhesive, a photographic paper, a liquid crystal layer, etc.

### SUMMARY OF THE INVENTION

It is therefore an object of the present invention to provide a microfluidic device having channels in which the surface properties may be altered using an external stimulus.

It is a further object of the present invention to provide a microfluidic device in which flow patterns within channels of the device can be established by use of the external stimulus.

It is a still further object of the present invention to provide a device in which changes in the surface properties of the channels of the device can be reversibly accomplished.

These and other objects of the present invention will be more readily apparent in the description and drawings that follow.

### BRIEF DESCRIPTION OF THE DRAWINGS

FIG. 1 is a cross-section view of a channel employing the principles of the present invention; and

FIG. 2 is a representation of a microfluidic cartridge embodying the present invention.

### DETAILED DESCRIPTION OF THE PREFERRED EMBODIMENT

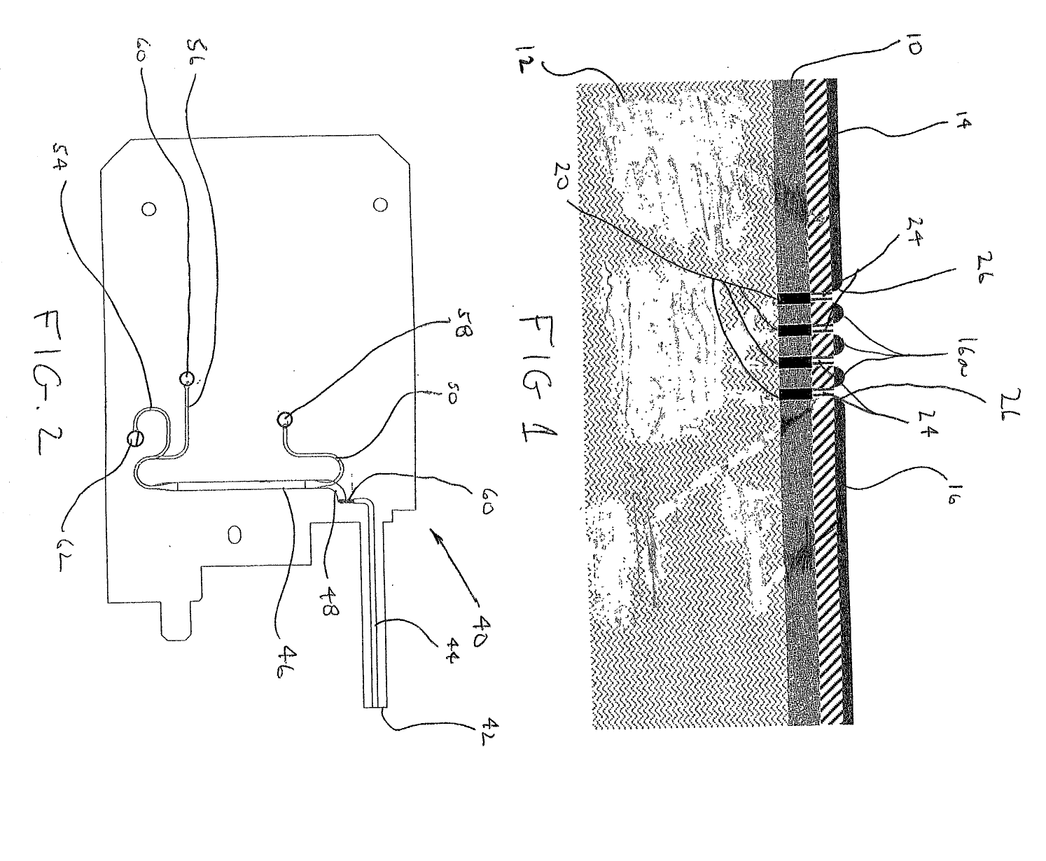

FIG. 1 is a representation of a sheet having the properties of the present invention. Referring now to FIG. 1, there is shown a sheet 10 which is supported by a substrate 12. Sheet 10 may comprise a channel within a microfluidic device. On the upper surface of sheet 10 a surface coating 14 is deposited. A fluid 16 flows across coating 14 on sheet 10. Substrate 12 may be composed of plastic or a similar material.

A series of electrodes 20 are embedded within sheet 10 in FIG. 1. When a voltage is applied to electrodes 20, properties of surface coating 14 are changed, as is shown at 24 in FIG. 1. This property change causes an interruption in the flow of fluid 16 across sheet 10 and coating 14, as is seen at 26.

In the present embodiment, surface coating 14 is changed from hydrophilic to hydrophobic upon the application of an electric charge to electrodes 20. Several isolated drops of fluid l6 can be seen at 16a between electrodes 20 in FIG. 1. By removing the electrical charge from electrodes 20, surface coating 14 will return to its hydrophilic state, allowing fluid 16 to resume its flow across sheet 10. It is also possible to use magnetic fields or sonic radiation to change the state of coating 14.

An example of electric field sensitive polymers is the complex of polyethyloxazoline and poly (methacrylic acid), which changes from a solid state to solution after an electric current is applied.

Temperature can be used to control the surface hydrophilicity of a microfluidic device. An example for this application is polymerized N-isopropylacrylamide, which shows a lower critical solution temperature (LCST) of 32° C. in the aqueous environment. The surface after coating is hydrophilic when the temperature is below 32° C. Upon heating to above 32° C., the surface becomes hydrophobic.

Photosensitive polymers can also switch between hydrophobic and hydrophilic states, depending on the light source. For example, copolymers of N,N-dimethyl acrylamide and 4-phenylazophenyl acrylate turn hydrophilic and dissolve in aqueous solution upon ultraviolet (UV) light (350 nm) irradiation, while copolymers of N,N-dimethyl acrylamide and N-4-phenylazophenyl acrylamide turn hydrophobic and precipitate upon UV light irradiation.

In addition, pH sensitive polymers such as polyacrylic acid can ionize reversibly at an inherent pH range and affect the polarity of the polymer. At pH 7, polyacrylic acid is hydrated and hydrophilic. When pH drops below 4, the polymer contracts and becomes hydrophobic.

Chemical coatings for modification of the surface chemistry of a microlfuidic device may be derived from one or more of the following to create multi-sensitivity surfaces: N-isopropylacrylamide, N-acetylacrylamide, N-acetylmethacrylamide, acrylic acid, propylacrylic acid, N,N-dimethyl acrylamide, 4-phenylazophenyl acrylate, N-4-phenylazophenyl acrylamide, ethyloxazoline, and methacrylic acid, acryl-L-amino acid amide, N-acryloyl pyrrolidine, N-acryloyl piperdline, hydroxypropyl acrylate, methylcellulose, ethylene oxide and vinyl methyl ether.

The surface coatings may be applied via plasma deposition. The monomers may be vaporized into the plasma reactor and deposited directly onto the desired surface areas of a microfluidic device. Alternatively, specific areas of a microfluidic device surface can be activated with argon plasma, coated with the desired chemicals dissolved in solvent, and further plasma treated with argon plasma to achieve the desired surface chemistry. Desired surface chemistry may also be achieved via absorption, surface grafting, and covalent or ionic chemical derivatization of specific polymers, which initially display abilities to switch between hydrophobic and hydrophilic states upon external stimuli. By applying a mask on the sheet of a microfluidic device, desired surface areas of the sheet can be chemically modified.

FIG. 2 shows a microfluidic cartridge which uses an embodiment of the present invention. Referring now to FIG. 2, there is shown a microfluidic cartridge, generally indicated at 40. Cartridge 40 is used to separate small molecules from a blood sample. Cartridge 40 contains an inlet 42 for receiving a blood sample. Inlet 42 is connected to an inlet channel 44 which is coupled to an H-Filter device 46. The H-Filter structure is described in detail in U.S. Pat. No. 5,932,100, the disclosure of which is hereby incorporated by reference.

H-Filter 46 is formed by a pair of inlet channels 48, 50, a main channel 52, and a pair of outlet channels 54, 56. A buffer inlet 58 is coupled to channel 50 at the end opposite H-Filter 46, while a sample collector port 60 is coupled to channel 56 at the end opposite H-Filter 46. A waste port 62 is coupled to channel 54 at the end opposite H-Filter 46. Finally, a section of hydrophobic responsive coating 60 is located at the junction between inlet channel 44 and H-Filter 46.

The operation of microfluidic cartridge 40 will now be described. A sample of blood is introduced to cartridge 40 at inlet 42. The sample is drawn into inlet channel 42 until it reaches coated section 60, where it stops due to surface tension within channel 42. An external energy control source is then applied to cartridge 40 and section 60 in the form of light, electric field, temperature, pH, or the like, which changes the hydrophobic surface on section 60 to a hydrophilic surface, which allows the blood sample within inlet channel 44 to enter H-Filter 46.

H-Filter 46 acts to separate small molecules from the blood sample using the process described in U.S. Pat. No. 5,932,100. The separated molecules enter sample collector port 60 via channel 56, while the rest of the fluid collects in waste port 62 via channel 54. The external force is again applied to cartridge 40 in order to reverse the property of surface coating 60 to the hydrophobic state to halt the blood flow from channel 44.

While the present invention has been shown and described in terms of several preferred embodiments thereof, it will be understood that this invention is not limited to these particular embodiments and that many changes and modifications may be made without departing from the true spirit and scope of the invention as defined in the appended claims.

What is claimed is:

1. A microfluidic device, comprising:
a sheet having a surface in contact with a fluid flow, said surface having a property which can be altered by an external force;
and means for applying the external force to said sheet, whereby said property of said sheet is altered in at least one area of said sheet such that fluid flow in contact with said sheet is changed.

2. The device of claim 1, wherein said external force stops said fluid flow across said sheet.

3. The device of claim 1, wherein said external force allows said fluid flow across said sheet.

4. The device of claim 1, wherein said sheet is composed of a substance taken from the group consisting of polymerized N-isopropylacrylamide, N-acetylacrylamide, N-acetylmethacrylamide, N,N-dimethyl acrylamide, N-4-phenylazophenyl acrylamide, acryl-L-amino acid amide, N-acryloyl pyrrolidine, N-acryloyl piperidine, acrylic acid, methacrylic acid, propylacrylic acid, hydroxypropyl acrylate, 4-phenylazophenyl acrylate, methylcellulose, ethyl oxazoline, ethylene oxide, and vinyl methyl ether.

5. The device of claim 4, wherein said external force is heat.

6. The device of claim 1, wherein said external force is an electric field.

7. The device of claim 1, wherein said external force comprises a light.

8. The device of claim 1, wherein said alteration of said property may be reversed.

9. The device of claim 1, wherein such external force is a magnetic field.

10. The device of claim 1, wherein said external force is sonic radiation.

11. The device of claim 1, wherein said external force is pH based.

12. A microfluidic device, comprising:
a substrate having an upper surface;
a coating contacting said upper surface of said substrate, said coating having a property which is altered by an external force;
a fluid flowing across said coating of said substrate;
and means for applying an external force to said coating,
whereby said property of said coating is altered such that fluid flow across said coating is changed upon application of said external force to said coating.

13. The device of claim 12, wherein said coating is deposited on said substrate using plasma deposition.

14. The device of claim 12, wherein said substrate is composed of plastic.

15. The device of claim 12, wherein said external force comprises an electric field.

16. The device of claim 12, wherein said alteration of said property is reversible.

17. The device of claim 12, wherein said external force comprises ultraviolet light.

18. The device of claim 12, wherein said fluid flow across said coating is stopped responsive to said external force.

19. The device of claim 12, wherein said coating is composed of a substance taken from the group consisting of polymerized N-isopropylacrylamide, N-acetylacrylamide, N-acetylmethacrylamide, N,N-dimethyl acrylamide, N-4-phenylazophenyl acrylamide, acryl- L-amino acid amide, N-acryloyl pyrrolidine, Nacryloyl piperidine, acrylic acid, methacrylic acid, propylacrylic acid, hydroxypropyl acrylate, 4-phenylazophenyl acrylate, methylcellulose, ethyl oxazoline, ethylene oxide, and vinyl methyl ether.
